(19) United States
(12) Patent Application Publication
(10) Pub. No.: US 2009/0026754 A1
(43) Pub. Date: Jan. 29, 2009

(54) METHOD AND SYSTEM FOR INCREASING SECURITY FOR CHILDREN AT A SOCIAL FUNCTION

(76) Inventor: William P. White, Gurnee, IL (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/781,621

(22) Filed: Jul. 23, 2007

(51) Int. Cl. B42D 15/10; B42F 5/00

(52) U.S. Cl. 283/75; 402/79

(57) ABSTRACT

A safety system for children at a social function includes a plurality of guest tags having blank spaces for providing the name of a child that is a guest at the social function, the name of a predetermined parent or other trusted adult responsible for the care of the child who may be contacted in the event of an emergency and/or take custody of the child at the time the child leaves the social function, and contact information of the parent or other trusted adult who may be contacted in the event of an emergency. The system allows a host of a social function for children to keep track of the attendees, identify any missing or unaccounted for children, and facilitates rapid notification of a parent or other trusted adult responsible for care of the child guest in the event of an emergency.

### FIELD OF THE INVENTION

This invention relates to child safety at social gatherings, and more particularly to a method and system for ensuring that a child attending a social function leaves the social function with a predetermined parent, custodian or other trusted adult, and/or to ensure that the host(s) have appropriate contact information for the child guest in the event of an emergency.

### BACKGROUND OF THE INVENTION

Children attending a social function, especially a large social function, and more especially a large social function at a location other than the home of a responsible adult host, can be susceptible to abduction or being otherwise harmed by strangers. This is especially true for younger children. Additionally, because many children are extremely curious and often much less adverse to accepting risks, there is a significant potential that a child may become injured, ill or otherwise encounter an emergency wherein it is necessary or at least desirable that a predetermined trusted adult responsible for care of the child is contacted. Even for smaller gatherings, it is not always possible for the host(s) to know the parents and/or other trusted adults responsible for care of all of the children attending the hosted social function, and/or to have all of the appropriate contact information readily available in the event of an emergency.

It is believed that there are not any known systems or products especially adapted to ensure that a host of a social function having child guests who are not accompanied by their parents or any other trusted adult responsible for care of the child will have appropriate and sufficient information to be able to contact the parent or other trusted adult in the event of an emergency and to make sure that the child guest leaves the event with a predetermined parent or other trusted adult.

A known identification system for children traveling as a group under the guidance of a teacher is described in U.S. Pat. No. 5,765,875. With this system, each child carries an identification tag on a frangible length of bead chain. Each tag has first identifying indicia such as an unduplicated number unique to the particular child carrying the tag, and second identifying indicia providing information relating to the group. This system is specifically adapted for use with children traveling as a group with a teacher and/or other trusted adult(s) and cannot be easily modified for use by hosts of a social event to ensure that a child guest leaves the social event with a predetermined trusted adult, and/or to ensure that the host has appropriate contact information in the event of an emergency.

### SUMMARY OF THE INVENTION

In one aspect of the invention, a system for accounting for children at a social function and/or for facilitating emergency notification of a trusted adult responsible for care of the child includes a plurality of guest tags having blank spaces for providing the name of a child that is a guest at the social function, the name of a predetermined parent or other trusted adult responsible for care of the child guest and who will take custody of the child at the time the child leaves the social function, and contact information for a parent or other trusted adult who may be contacted in the event of an emergency during the social function; and instructions (e.g., indicia proximate the blank lines) to fill in the blanks with the appropriate information and deliver the completed guest tag to a host of the social function at the time that the child guest is brought to the social function.

In a further aspect of the invention, the system further comprises instructions for the host of the social function to collect and retain each completed guest tag before admitting the child guest to the social function, and to retain the guest tag until the child guest has left the social function with the predetermined parent or other trusted adult.

In a still further aspect of the invention, each guest tag is a portion of a frangible invitation.

In another aspect of the invention, the system further includes a binder for retaining a plurality of the guest tags together during the social function.

In another aspect of the invention, each of the guest tags includes a blank space for the signature of the parent or other trusted adult to indicate that the custody of the child has been transferred from the host to the parent or other trusted adult and that the child guest associated with the guest tag has left the social function with the predetermined parent or other trusted adult.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a front view of a packaged safety kit in accordance with an aspect of the invention.

FIG. 2 is a front view of a combination invitation card and guest tag in accordance with an aspect of the invention.

### DETAILED DESCRIPTION OF PREFERRED EMBODIMENTS

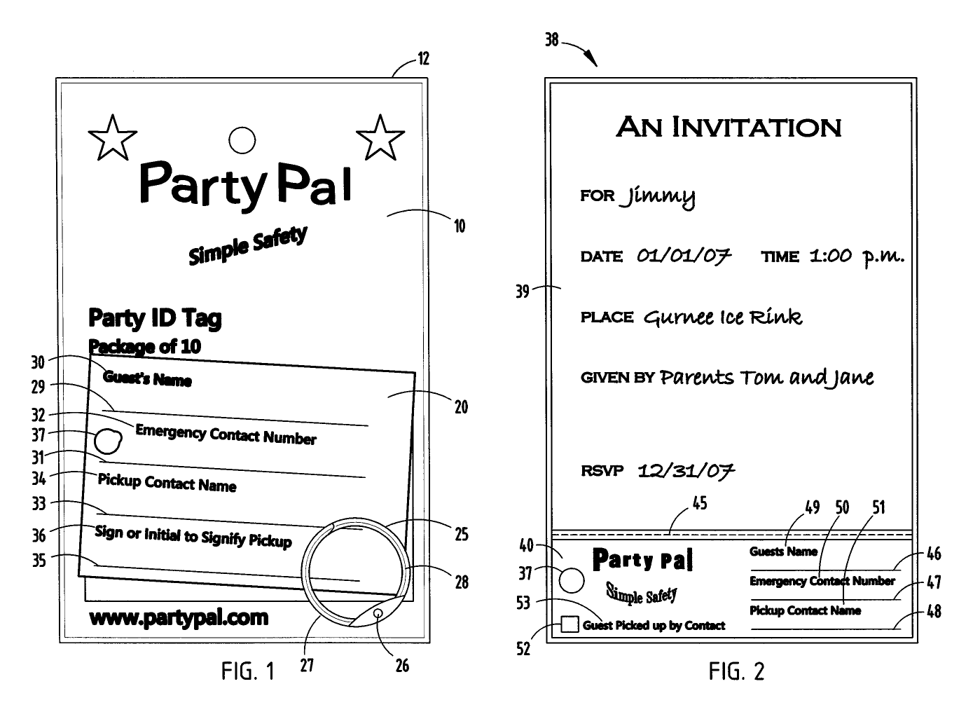

In accordance with an embodiment of the invention, there is shown in FIG. 1 a packaged safety kit 10 for accounting for children at a social function and for facilitating emergency notification of a parent or other predetermined trusted adult. The packaged kit 10 includes a package 12 (e.g., a transparent plastic bag), a plurality of guest tags 20, and a binder 25 for retaining the guest tags together during the social function.

In the illustrated embodiment, binder 25 is a metal or plastic ring having a hinge 26 for pivoting openable ring sections 27 and 28. Distal ends of ring sections 27 and 28 opposite the hinge ends may be provided with interlocking barbs or other structure for locking the ring sections in a closed configuration to securely retain guest tags 20. Alternatively, other binders, such as loose-leaf binders, clasps, clips, or other suitable devices may be employed.

Each guest tag 20 includes a blank line 29 for filling in the name of an invited guest to the social function along with suitable indicia 30 proximate blank line 29 to indicate that line 29 is for the guest's name, a blank line 31 for emergency contact information along with appropriate indicia 32 indicating that line 31 is for emergency contact information (e.g., a telephone number), and a blank line 33 for filing in the name of a parent or other trusted adult that will accompany the child guest from the social function, along with appropriate indicia 34 indicating that line 33 is for the name of the trusted adult that will accompany the child guest from the social function. In certain embodiments, guest tag 20 will further include a blank line 35 that is to be signed or initialed by the predetermined parent or other trusted adult indicated in blank line 33 when that parent or other trusted adult takes custody of the child guest and leaves with the child guest. Indicia 36 proximate line 35 is provided to indicate that the parent is to sign or initial blank line 35 to signify that the parent or other trusted adult has picked up the child guest from the social function. This allows the host to keep track of and to account for all of the child guests at the social function. Each tag 20 may also include an opening or aperture 37 though which a binder (e.g., ring 25) may be inserted for retaining tags 20 together.

Each packaged safety kit 10 contains a predetermined quantity of guest tags 20, such as 10, 20 or 50, and a single binder or ring 25. Guest tags 20 and binder or ring 25 are preferably packaged in transparent plastic (e.g., a plastic bag or plastic wrap), which allows the contents of the packaged safety kit to be easily viewed while on a display rack.

In accordance with an alternative embodiment of the invention, which may be packaged in similar quantities and in a similar manner to guest tags 20 of FIG. 1, there is shown in FIG. 2 a frangible invitation card comprising two separable sections, including a greeting or invitation section 39 and a guest tag section 40. Sections 39 and 40 are separable from each other along a line of perforations 45. The invitation or greeting section 39 may include various preprinted matter (as indicated in FIG. 2) to advise a recipient that they have been invited to a social function. In the illustrated embodiment, preprinted matter and space is available for indicating the subject matter or nature of the social gathering, the date, time and place of the social gathering, the adult(s) hosting the social gathering, and optionally a request that the invitee advise the host whether they will be attending (RSVP). As with the guest tag shown in FIG. 1, guest tag 40 of frangible invitation card 38 includes blank lines 46, 47 and 48 and corresponding indicia 49, 50 and 51 indicating that the blank lines are for the guest's name, emergency contact information (telephone number), and the pickup contact name, respectively. In addition, section 40 of frangible invitation card 38 may also include a blank line for the signature or initials of the pickup contact person. Alternatively, section 40 may include a check box 52 and corresponding indicia 53 indicating that the check box is to be marked when the child guest has been picked up by the predetermined trusted adult contact. This provides an alternative method for the host to keep track of which guests have been picked up by a predetermined trusted adult.

The packaged safety kits of this invention, in addition to including a plurality of guest tags 20 or frangible invitation cards 38, will desirably include instructions on their use. For example, a set of instructions to the purchaser of the packaged safety kit 10 may recommend that a guest tag 20 be included with a conventional invitation card, and that the purchaser instruct (e.g., on the conventional invitation card) that the parent of the invited child guest complete and return the included guest tag 20 to the named host(s) before or at the time that the child guest is brought to the social function to which the child guest has been invited. In addition, appropriate instructions may be provided on either the front or backside of the guest tag 20 and/or frangible invitation card 38.

The above description is considered that of the preferred embodiment(s) only. Modifications of the invention will occur to those skilled in the art and to those who make or use the invention. Therefore, it is understood that the embodiment(s) shown in the drawings and described above are merely for illustrative purposes and not intended to limit the scope of the invention, which is defined by the following claims as interpreted according to the principles of patent law, including the doctrine of equivalents.

The invention claimed is:

1. A system for accounting for children at a social function and/or for facilitating emergency notification of a parent or other predetermined trusted adult, comprising:
a plurality of guest tags having blank spaces for providing a name of a child that is a guest at the social function, a name of a predetermined parent or trusted adult that is to be contacted in an emergency, and a telephone number of the predetermined parent or other trusted adult that is to be contacted in an emergency; and
instructions to fill in the blanks on the guest tag and delivery the guest tag along with the guest to an adult host at the social function.

2. The system of claim 1, further comprising instructions that the adult host collect and retain each completed guest tag during the social function at least until the guest has left the social function with the predetermined parent or other trusted adult that is to be contacted in the event of an emergency and/or has been designated as the person in charge of picking up the child guest from the social function.

3. The system of claim 1, wherein the guest tag is a portion of a frangible invitation and/or greeting card.

4. The system of claim 3, wherein the guest tag is separable from the invitation or greeting card along a line of perforations.

5. The system of claim 1, further comprising a binder for retaining a plurality of guest tags, and wherein each guest tag includes at least one aperture though which the binder may be inserted.

6. A package safety kit for accounting for children at a social function and/or for facilitating emergency notification of a predetermined parent or other trusted adult, comprising:
a package;
a plurality of guest tags contained in the package, each guest tag having blank spaces for providing a name of a child that is a guest at the social function, a name of a predetermined parent or other trusted adult that is to be contacted in an emergency, and a telephone number of the predetermined parent or other trusted adult that is to be contacted in an emergency; and
instructions contained in the package advising a host to mail or otherwise deliver to the parent or legal guardian of a child guest, one of the guest tags and instructions to fill in the blanks, and to collect and retain each completed guest tag during the social function until the guest has left the social function with the predetermined parent or other trusted adult.

7. The packaged safety kit of claim 6, wherein the guest tag is a portion of a frangible invitation and/or greeting card.

8. The packaged safety kit of claim 7, wherein the guest tag is separable from the invitation or greeting card along a line of perforations.

9. The packaged safety kit of claim 6, further comprising a binder for retaining a plurality of guest tags, and wherein each guest tag includes an aperture through which the binder may be inserted.

10. A frangible invitation card comprising two separable sections, a first one of the sections being a guest tag having blank spaces and corresponding indicia for a name of a child that is guest at the social function, a name of a predetermined parent or other trusted adult that is to be contacted in an emergency, and a telephone number of the predetermined parent or other trusted adult that is to be contacted in an emergency, and a second one of the sections being an invitation or greeting card.

11. The frangible invitation card of claim 10, further comprising printed instructions for an adult host to collect and retain each completed guest tag during the social function until the guest has left the social function with the predetermined parent or other trusted adult.

12. The frangible invitation card of claim 10, wherein the guest tag is separable from the invitation or greeting card along a line of perforations.

13. The frangible invitation card of claim 10, wherein the guest tag includes an aperture through which a binder may be inserted.
